(19) United States
(12) Patent Application Publication
(10) Pub. No.: US 2024/0353533 A1
(43) Pub. Date: Oct. 24, 2024

(54) DISTANCE MEASUREMENT DEVICE

(71) Applicant: FUJIFILM CORPORATION, Tokyo (JP)

(72) Inventors: Kouhei AWAZU, Kanagawa (JP); Yoshitaka MORI, Kanagawa (JP); Tsuyoshi MITARAI, Kanagawa (JP)

(21) Appl. No.: 18/760,113

(22) Filed: Jul. 1, 2024

Related U.S. Application Data
(63) Continuation of application No. PCT/JP2022/046732, filed on Dec. 19, 2022.

(30) Foreign Application Priority Data
Feb. 15, 2022 (JP) 2022-021534

(51) Int. Cl. G01S 7/481

(52) U.S. Cl. CPC G01S 7/4811; G01S 7/4817

(57) ABSTRACT

A distance measurement device includes a light source that emits scanning light, a light receiving sensor that receives returning light, an incidence and emission window that has an annular shape centered at a reference axis set in advance and that is capable of omnidirectionally emitting the scanning light about the reference axis and capable of receiving the incident returning light, a light deflector that includes a movable mirror portion which reflects the scanning light from the light source toward the incidence and emission window and which reflects the returning light from the incidence and emission window toward the light receiving sensor, and that changes a direction of the scanning light by changing a posture of a movable reflection surface, and a relay optical system that relays the scanning light and the returning light between the movable mirror portion and each of the light source and the light receiving sensor.

### CROSS-REFERENCE TO RELATED APPLICATIONS

This application is a continuation application of International Application No. PCT/JP2022/046732, filed on Dec. 19, 2022, which is incorporated herein by reference in its entirety. Further, this application claims priority from Japanese Patent Application No. 2022-021534, filed on Feb. 15, 2022, the disclosure of which is incorporated by reference herein in its entirety.

### BACKGROUND

### Technical Field

The disclosed technology relates to a distance measurement device.

### Related Art

JP2021-081593A discloses a movable device applied to a light scanning system. The movable device includes a light deflector that includes a movable portion having a reflection surface and that can rotationally move the movable portion about a predetermined rotational axis, a pedestal including a pair of fixing portions that fix the light deflector, and a substrate bonded to the pedestal on a side of the pedestal opposite to a side on which the light deflector is fixed, in which a through hole is provided at a position between the pair of fixing portions on the substrate.

JP2021-156882A discloses a photoelectric sensor (10), particularly a laser scanner, for acquiring distance measurement data of an object in a monitoring region (20) comprising a measurement unit comprising a light emitter (12) for emitting emission light (16) to the monitoring region (20) at a plurality of angles and a light receiver (26) for generating a light receiving signal from received light (22) incident from the monitoring region (20) at a plurality of angles, and a control and evaluation unit (36) configured to acquire the distance measurement data having an angular resolution and a temporal resolution by measuring a light propagation time from the light receiving signal using the plurality of angles and repeated measurement, in which the control and evaluation unit (36) is further configured to create an image (46) in which pixels including distance values are arranged in an angular dimension and a temporal dimension by arranging the distance measurement data, and assign a class to each pixel by evaluating the image (46) through image classification processing (48) in machine learning.

### SUMMARY

An object of the disclosed technology is to provide a distance measurement device that can implement size reduction of the device.

In order to achieve the object, a first aspect according to the disclosed technology is a distance measurement device that measures a distance to a target object by emitting scanning light and receiving returning light obtained by reflection of the scanning light by the target object, the distance measurement device comprising a light source that emits the scanning light, a light receiving sensor that receives the returning light and that outputs a light receiving signal corresponding to the received returning light, an incidence and emission window that has an annular shape centered at a reference axis set in advance and that is capable of omnidirectionally emitting the scanning light about the reference axis and capable of receiving the returning light incident from the target object, a light deflector that includes a movable mirror portion which includes a movable reflection surface disposed at a position at which the movable reflection surface intersects with the reference axis and which reflects the scanning light from the light source toward the incidence and emission window and reflects the returning light from the incidence and emission window toward the light receiving sensor, and that omnidirectionally changes a direction of the scanning light by changing a posture of the movable reflection surface, and a relay optical system that relays the scanning light and the returning light between the movable mirror portion and each of the light source and the light receiving sensor, in which in a direction along the reference axis, in a case where a direction in which the movable reflection surface faces with reference to the light deflector is referred to as a side closer to a first end of the reference axis, and a side opposite to the side closer to the first end of the reference axis is referred to as a side closer to a second end of the reference axis, the incidence and emission window is disposed on the side closer to the first end, and the light source and the light receiving sensor are disposed on the side closer to the second end.

A second aspect according to the disclosed technology is the distance measurement device according to the first aspect, in which in a case where two axes orthogonal to each other in a plane of which a normal is the reference axis are referred to as a first axis and a second axis, the movable mirror portion is a two-axis rotary mirror capable of rotating about each of the first axis and the second axis and, in a case where a position at which the movable reflection surface is orthogonal to the reference axis is referred to as an initial position, the movable mirror portion changes a direction in which the scanning light is emitted in a conical shape about the reference axis by rotating about each of the first axis and the second axis in a positive direction and a negative direction with reference to the initial position.

A third aspect according to the disclosed technology is the distance measurement device according to the second aspect, in which the movable mirror portion changes the direction in which the scanning light is emitted in a helical shape about the reference axis.

A fourth aspect according to the disclosed technology is the distance measurement device according to the second aspect or the third aspect, further comprising an emission angle changing optical system disposed on the side closer to the first end, in which in the emission angle changing optical system, an emission angle that is an angle of the scanning light emitted from the incidence and emission window with respect to the reference axis is set to be greater than a reflection angle that is an angle of the scanning light reflected by the movable reflection surface with respect to the reference axis.

A fifth aspect according to the disclosed technology is the distance measurement device according to the fourth aspect, in which in the emission angle changing optical system, a range of the emission angle is further set to be wider than a range of the reflection angle defined by a movable range of the movable mirror portion.

A sixth aspect according to the disclosed technology is the distance measurement device according to the fourth aspect or the fifth aspect, in which in a case where the scanning light that passes through the relay optical system to travel along the reference axis from the side closer to the first end is incident on the movable mirror portion, the emission angle changing optical system includes a first annular reflection mirror having a first reflection surface on which an opening is formed at a center corresponding to the reference axis as an optical path of the scanning light, the first reflection surface having an annular shape that is centered at the reference axis and that extends in a diameter direction orthogonal to the reference axis, and a second annular reflection mirror having a second reflection surface disposed to face the first reflection surface, the second reflection surface having an annular shape in which an opening is formed at a center like the first reflection surface and having a convex shape toward the side closer to the first end, the first annular reflection mirror reflects the scanning light that is reflected by the movable reflection surface to travel toward the side closer to the first end, toward the second reflection surface via the first reflection surface, and the second annular reflection mirror reflects the scanning light incident on the second reflection surface from the first reflection surface toward the incidence and emission window.

A seventh aspect according to the disclosed technology is the distance measurement device according to the fourth aspect or the fifth aspect, in which in a case where the scanning light that passes through the relay optical system to travel along the reference axis from the side closer to the first end is incident on the movable mirror portion, the emission angle changing optical system includes a third annular reflection mirror having a third reflection surface on which an opening is formed at a center corresponding to the reference axis as an optical path of the scanning light, the third reflection surface having an annular shape that is centered at the reference axis and that extends in a diameter direction orthogonal to the reference axis and having a convex shape toward the side closer to the second end, and the third annular reflection mirror reflects the scanning light that is reflected by the movable reflection surface to travel toward the side closer to the first end, toward the incidence and emission window via the third reflection surface.

An eighth aspect according to the disclosed technology is the distance measurement device according to any one of the first aspect to the seventh aspect, in which the incidence and emission window is an omnidirectional lens having a refractive power for refracting the omnidirectionally emitted scanning light, and in the omnidirectional lens, a cross-sectional shape in the direction along the reference axis is a shape of which a thickness in a diameter direction orthogonal to the reference axis is increased from one of the side closer to the first end and the side closer to the second end of the reference axis toward the other.

A ninth aspect according to the disclosed technology is the distance measurement device according to the sixth aspect and the eighth aspect, in which in the omnidirectional lens, a cross-sectional shape in the direction along the reference axis is a shape of which a thickness in a diameter direction is increased from the side closer to the first end toward the side closer to the second end of the reference axis.

A tenth aspect according to the disclosed technology is the distance measurement device according to the seventh aspect and the eighth aspect, in which in the omnidirectional lens, a cross-sectional shape in the direction along the reference axis is a shape of which a thickness in a diameter direction is increased from the side closer to the second end toward the side closer to the first end of the reference axis.

An eleventh aspect according to the disclosed technology is the distance measurement device according to any one of the first aspect to the tenth aspect, in which a first relay element that constitutes a part of the relay optical system and that allows transmission of the scanning light emitted by the light source and reflects the returning light to the light receiving sensor is disposed on the side closer to the second end in addition to the light source and the light receiving sensor, and the light source, the light receiving sensor, and the first relay element are further disposed to at least partially overlap with each other in the direction along the reference axis.

A twelfth aspect according to the disclosed technology is the distance measurement device according to the eleventh aspect, in which the relay optical system includes a second relay element that is disposed on the side closer to the second end and that reflects the scanning light which has passed through the first relay element to the side closer to the first end, a third relay element that is disposed on the side closer to the first end and that reflects the scanning light reflected by the second relay element in a direction intersecting with the reference axis, and a fourth relay element that is disposed on the side closer to the first end and that reflects the scanning light reflected by the third relay element toward the movable mirror portion, and the relay optical system relays the returning light in an order of the fourth relay element, the third relay element, the second relay element, and the first relay element.

A thirteenth aspect according to the disclosed technology is the distance measurement device according to any one of the first aspect to the twelfth aspect, in which the light receiving sensor is composed of one photodiode.

A fourteenth aspect according to the disclosed technology is the distance measurement device according to any one of the first aspect to the thirteenth aspect, in which the light source is a laser light source that emits laser light as the scanning light.

A fifteenth aspect according to the disclosed technology is the distance measurement device according to any one of the first aspect to the fourteenth aspect, further comprising an angle sensor for detecting a rotation angle of the movable reflection surface, in which the angle sensor is disposed on the side closer to the second end.

According to the disclosed technology, a distance measurement device that can implement size reduction of the device can be provided.

### BRIEF DESCRIPTION OF THE DRAWINGS

FIG. 1 is a block diagram illustrating an example of a schematic configuration of a LiDAR device.

FIG. 2 is a perspective view illustrating an example of a schematic configuration of a movable mirror portion.

FIG. 3 is a diagram illustrating a state where the movable mirror portion performs a precessional motion.

FIG. 4 is a schematic perspective view illustrating an example of an emission angle changing optical system.

FIG. 5 is a schematic exploded perspective view illustrating an example of the emission angle changing optical system.

FIG. 6 is a schematic cross-sectional view illustrating an example of the emission angle changing optical system.

FIG. 7 is a diagram for describing a positional relationship among a first reflection surface, a second reflection surface, and the movable mirror portion.

FIG. 8 is a diagram schematically illustrating an example of a change in an emission direction of scanning light.

FIG. 9 is a cross-sectional perspective view illustrating an example of a schematic configuration of a LiDAR device according to a first embodiment.

FIG. 10 is a schematic configuration diagram illustrating an example of disposition of a light source, a light receiving sensor, and a first relay element.

FIG. 11 is a cross-sectional perspective view illustrating an example of a schematic configuration of a LiDAR device according to a modification example.

FIG. 12 is a schematic configuration diagram for describing a positional relationship of an angle sensor according to the modification example.

FIG. 13 is a diagram schematically illustrating another example of the change in the emission direction of the scanning light.

FIG. 14 is a schematic cross-sectional view illustrating an example of an emission angle changing optical system according to a second embodiment.

### DETAILED DESCRIPTION

Examples of embodiments according to the disclosed technology will be described in accordance with the accompanying drawings.

### First Embodiment

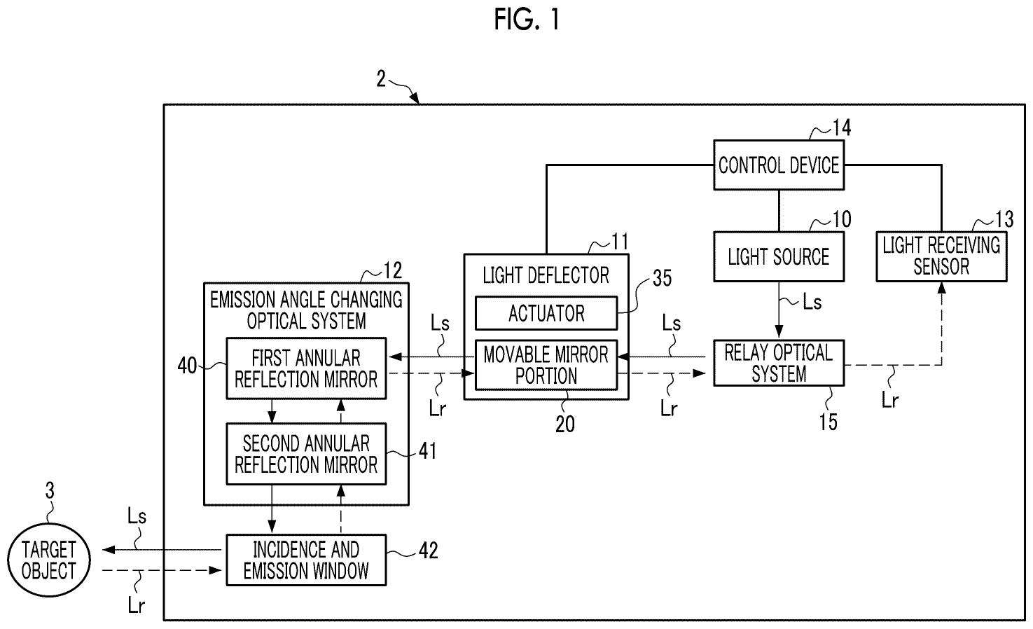

FIG. 1 illustrates a schematic configuration of a light detection and ranging (LiDAR) device 2 according to a first embodiment. The LiDAR device 2 measures a distance to a target object 3 by emitting scanning light Ls and receiving returning light Lr obtained by reflection of the scanning light Ls by the target object 3. The LiDAR device 2 is mounted on, for example, an automobile and acquires distance information of a surrounding obstacle. The LiDAR device 2 is an example of a “distance measurement device” according to the disclosed technology, the scanning light Ls is an example of “scanning light” according to the disclosed technology, and the returning light Lr is an example of “returning light” according to the disclosed technology.

As illustrated in FIG. 1, the LiDAR device 2 comprises a light source 10, a light deflector 11, an emission angle changing optical system 12, a light receiving sensor 13, a control device 14, a relay optical system 15, and an incidence and emission window 42. The light deflector 11 includes a movable mirror portion 20 and an actuator 35 for driving the movable mirror portion 20. The emission angle changing optical system 12 includes a first annular reflection mirror 40 and a second annular reflection mirror 41.

The light source 10 emits the scanning light Ls. For example, the light source 10 is a laser diode, and the scanning light Ls is laser light. The laser light is, for example, an infrared ray having a wavelength of 905 nm. In addition, the laser light has, for example, a pulsed shape. The light source 10 is an example of a “light source” according to the disclosed technology, and the laser light is an example of “laser light” according to the disclosed technology. In addition, hereinafter, the scanning light Ls and the returning light Lr obtained by reflection of the scanning light Ls by the target object 3 may be collectively referred to as the laser light.

The light source 10 is not limited to the laser diode, and laser light sources of various configurations such as a diode pumped solid state (DPSS) laser and a fiber laser can be used. In addition, the laser light is not limited to the above laser light, and pulsed laser light that has a wavelength of, for example, 850 nm to 1550 nm up to a near-infrared range and that is generally used for LiDAR can be used.

The relay optical system 15 relays the scanning light Ls between the light source 10 and the movable mirror portion 20. In addition, the relay optical system 15 relays the returning light Lr between the movable mirror portion 20 and the light receiving sensor 13. The relay optical system 15 is an example of a “relay optical system” according to the disclosed technology.

The movable mirror portion 20 deflects the scanning light Ls by reflecting the scanning light Ls incident through the relay optical system 15. The scanning light Ls emitted from the movable mirror portion 20 is incident on the emission angle changing optical system 12. The scanning light Ls incident on the emission angle changing optical system 12 is reflected by the first annular reflection mirror 40 and the second annular reflection mirror 41 in this order and is emitted outside the LiDAR device 2 from the incidence and emission window 42. The movable mirror portion 20 is an example of a “movable mirror portion” according to the disclosed technology.

The returning light Lr from the target object 3 is incident into the LiDAR device 2 from the incidence and emission window 42. The returning light Lr incident on the emission angle changing optical system 12 is reflected by the second annular reflection mirror 41 and the first annular reflection mirror 40 in this order and is then incident on the movable mirror portion 20. The returning light Lr incident on the movable mirror portion 20 is deflected by the movable mirror portion 20 and is then relayed by the relay optical system 15 to be guided to the light receiving sensor 13.

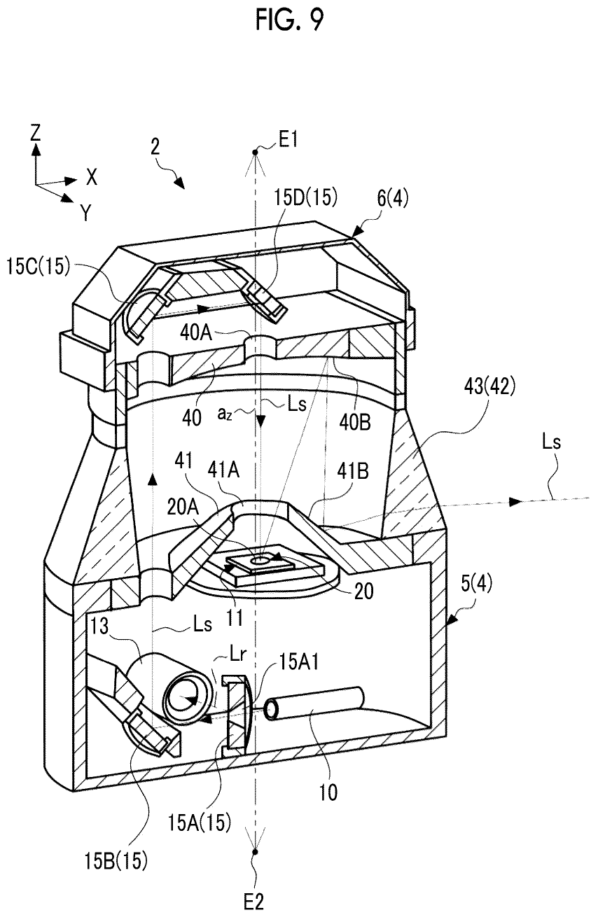

The light receiving sensor 13 receives the returning light Lr and outputs a light receiving signal corresponding to a light quantity of the received returning light Lr. The light receiving sensor 13 is composed of one photodiode. For example, the light receiving sensor 13 is composed of an avalanche photodiode (refer to FIG. 9). The light receiving signal generated by the light receiving sensor 13 is input into the control device 14. The light receiving sensor 13 is an example of a “light receiving sensor” according to the disclosed technology.

The control device 14 controls emission of the scanning light Ls from the light source 10 and performs processing of calculating the distance to the target object 3 based on the light receiving signal input from the light receiving sensor 13. In addition, the control device 14 supplies a drive voltage for driving the movable mirror portion 20 to the actuator 35. While an example of a form in which the control device 14 is included in the LiDAR device 2 has been described, the disclosed technology is not limited to this. For example, the control device 14 may be provided outside the LiDAR device 2 in a state where the control device 14 is electrically connected to the LiDAR device 2.

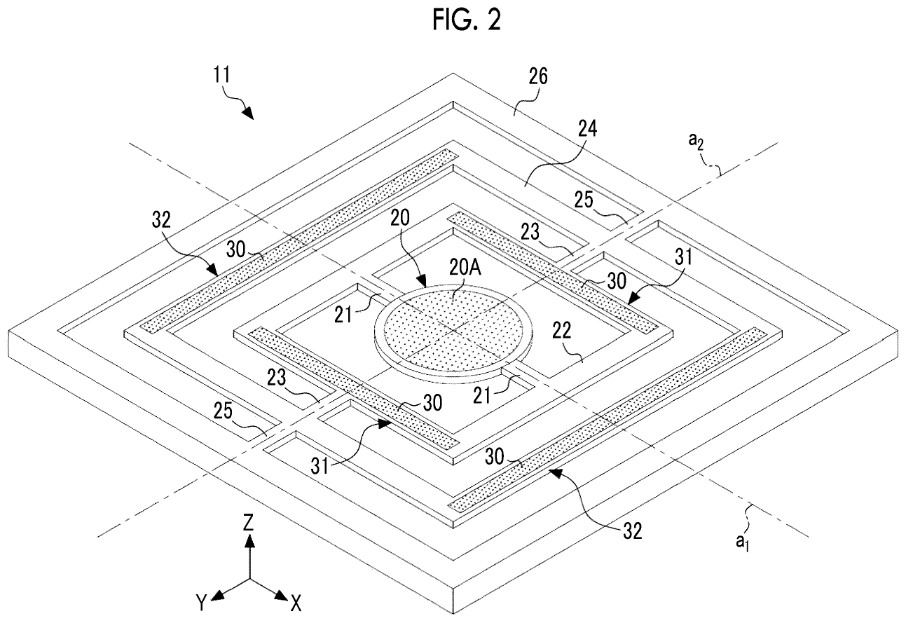

FIG. 2 illustrates a schematic configuration of the light deflector 11. The light deflector 11 is a micromirror device formed by performing etching treatment on a silicon on insulator (SOI) substrate. The light deflector 11 is also referred to as a micro electro mechanical systems (MEMS) mirror device. The light deflector 11 is an example of a “light deflector” according to the disclosed technology.

The light deflector 11 includes the movable mirror portion 20, a first support portion 21, a first movable frame 22, a second support portion 23, a second movable frame 24, a connecting portion 25, and a fixed frame 26. The light deflector 11 is a so-called MEMS scanner.

The movable mirror portion 20 has a movable reflection surface 20A that reflects an incidence ray such as the scanning light Ls. The movable reflection surface 20A is formed with a thin metal film of, for example, gold (Au), aluminum (Al), silver (Ag), or an alloy of silver provided on one surface of the movable mirror portion 20. A shape of the movable reflection surface 20A is, for example, a circular shape centered at an intersection between an axis a₁ and an axis a₂. The movable reflection surface 20A is an example of a “movable reflection surface” according to the disclosed technology.

The movable mirror portion 20 is a two-axis rotary mirror capable of rotating about each of the axis a₁ and the axis a₂. The axis a₁ is an example of a “first axis” according to the disclosed technology, and the axis a₂ is an example of a “second axis” according to the disclosed technology.

The first support portion 21 is disposed at each of positions that face each other across the axis a₂ outside the movable mirror portion 20. The first support portions 21 are connected to the movable mirror portion 20 on the axis a₁ and support the movable mirror portion 20 such that the movable mirror portion 20 can swing about the axis a₁. In the present embodiment, the first support portions 21 are torsion bars extending along the axis a₁.

The first movable frame 22 is a frame surrounding the movable mirror portion 20 and is connected to the movable mirror portion 20 through the first support portions 21 on the axis a₁. A piezoelectric element 30 is formed at each of positions that face each other across the axis a₁ on the first movable frame 22. Accordingly, a pair of first actuators 31 are configured by forming two piezoelectric elements 30 on the first movable frame 22.

The pair of first actuators 31 are disposed at positions that face each other across the axis a₁. The first actuators 31 cause the movable mirror portion 20 to swing about the axis a₁ by applying rotational torque about the axis a₁ to the movable mirror portion 20.

The second support portion 23 is disposed at each of positions that face each other across the axis a₁ outside the first movable frame 22. The second support portions 23 are connected to the first movable frame 22 on the axis a₂ and support the first movable frame 22 and the movable mirror portion 20 such that the first movable frame 22 and the movable mirror portion 22 can swing about the axis a₂. In the present embodiment, the second support portions 23 are torsion bars extending along the axis a₂.

The second movable frame 24 is a frame having a rectangular shape surrounding the first movable frame 22 and is connected to the first movable frame 22 through the second support portions 23 on the axis a₂. The piezoelectric element 30 is formed at each of positions that face each other across the axis a₂ on the second movable frame 24. Accordingly, a pair of second actuators 32 are configured by forming two piezoelectric elements 30 on the second movable frame 24.

The pair of second actuators 32 are disposed at positions that face each other across the axis a₂. The second actuators 32 cause the movable mirror portion 20 to swing about the axis a₂ by applying rotational torque about the axis a₂ to the movable mirror portion 20 and the first movable frame 22.

The connecting portion 25 is disposed at each of positions that face each other across the axis a₁ outside the second movable frame 24. The connecting portions 25 are connected to the second movable frame 24 on the axis a₂.

The fixed frame 26 is a frame having a rectangular shape surrounding the second movable frame 24 and is connected to the second movable frame 24 through the connecting portions 25 on the axis a₂.

In the following description, a normal direction of the movable reflection surface 20A in a state where the movable mirror portion 20 is not inclined will be referred to as a Z axis direction, one direction orthogonal to the Z axis direction will be referred to as an X axis direction, and a direction orthogonal to the Z axis direction and the X axis direction will be referred to as a Y axis direction.

The pair of first actuators 31 and the pair of second actuators 32 correspond to the actuator 35 (refer to FIG. 1). The control device 14 causes the movable mirror portion 20 to perform a precessional motion by applying sinusoidal drive voltages having phases different from each other to the pair of first actuators 31 and the pair of second actuators 32.

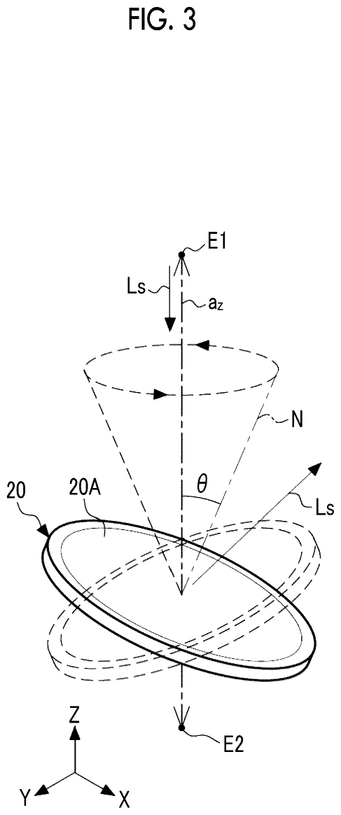

FIG. 3 illustrates a state where the movable mirror portion 20 performs the precessional motion. The precessional motion is a motion of a normal line N of the movable reflection surface 20A of the movable mirror portion 20 such that the normal line N draws a circle. That is, a position at which the movable reflection surface 20A is orthogonal to a Z axis a_{Z} in the movable mirror portion 20 will be referred to as an initial position. In this case, the movable mirror portion 20 rotates about each of the axis a₁ and the axis a₂ in a positive direction and a negative direction with reference to the initial position. Here, in a direction along the Z axis a_{Z}, a side in a direction in which the movable reflection surface 20A faces with reference to the light deflector 11 will be referred to as a side closer to a first end E1 of the Z axis a_{Z}, and a side opposite to the side closer to the first end E1 of the Z axis a_{Z} will be referred to as a side closer to a second end E2 of the Z axis a_{Z}. Here, the Z axis a_{Z} is, of course, an imaginary axis, and the first end E1 and the second end E2 are also imaginary end points conceived on the imaginary axis. The Z axis a_{Z} is an axis that is parallel to the Z axis direction and that passes through a center of the movable mirror portion 20. The Z axis a_{Z} is an example of a “reference axis” according to the disclosed technology.

The movable reflection surface 20A of the movable mirror portion 20 is disposed at a position at which the movable reflection surface 20A intersects with the Z axis a_{Z}. The scanning light Ls emitted from the light source 10 is incident at the center of the movable mirror portion 20 along the Z axis a_{Z}. The scanning light Ls that is deflected by the movable mirror portion 20 performing the precessional motion as illustrated in FIG. 3 is emitted from the movable mirror portion 20 such that the scanning light Ls draws a circle. For example, the movable mirror portion 20 changes a direction in which the scanning light Ls is emitted in a conical shape about the Z axis a_{Z}. Accordingly, by changing a posture of the movable reflection surface 20A of the movable mirror portion 20, the light deflector 11 omnidirectionally changes the direction of the scanning light Ls about the Z axis a_{Z} corresponding to the reference axis. In the present embodiment, the expression “omnidirectional about the reference axis” refers to not only 360° around the Z axis a_{Z} but also being omnidirectional in a sense including an error that is generally allowed in the technical field to which the disclosed technology belongs and that does not contradict the gist of the disclosed technology.

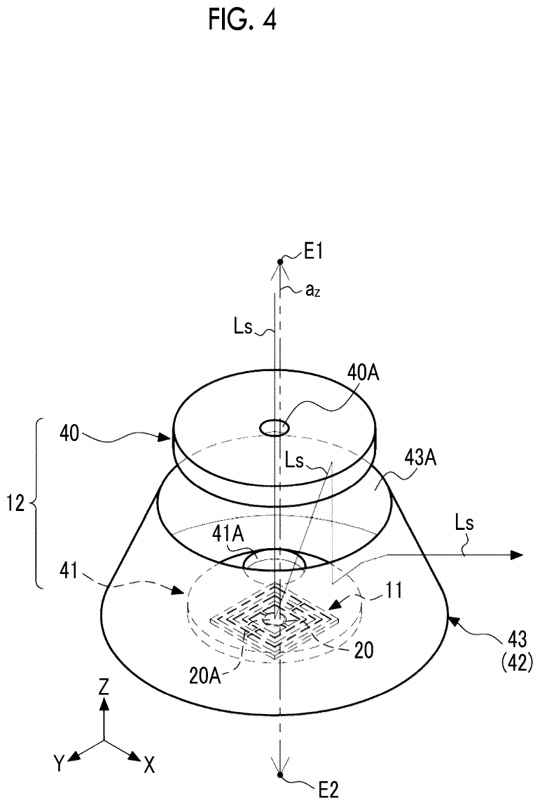

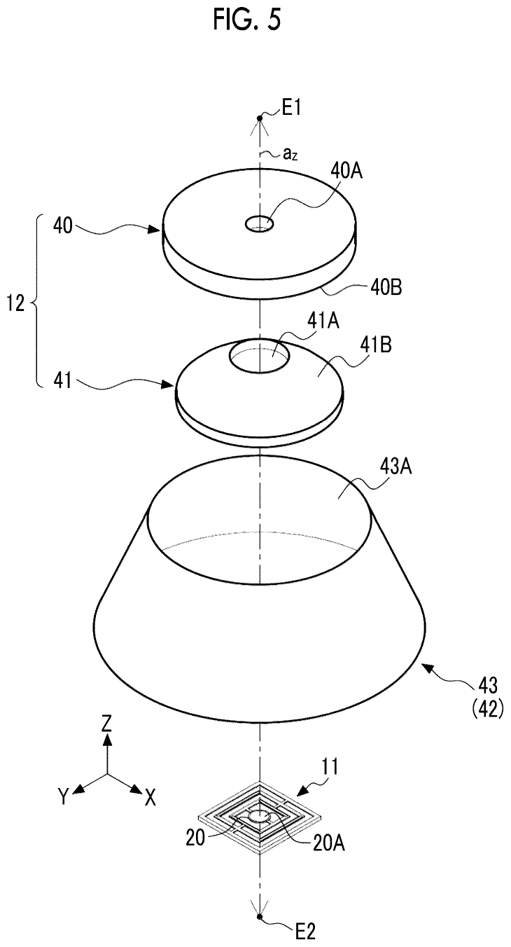

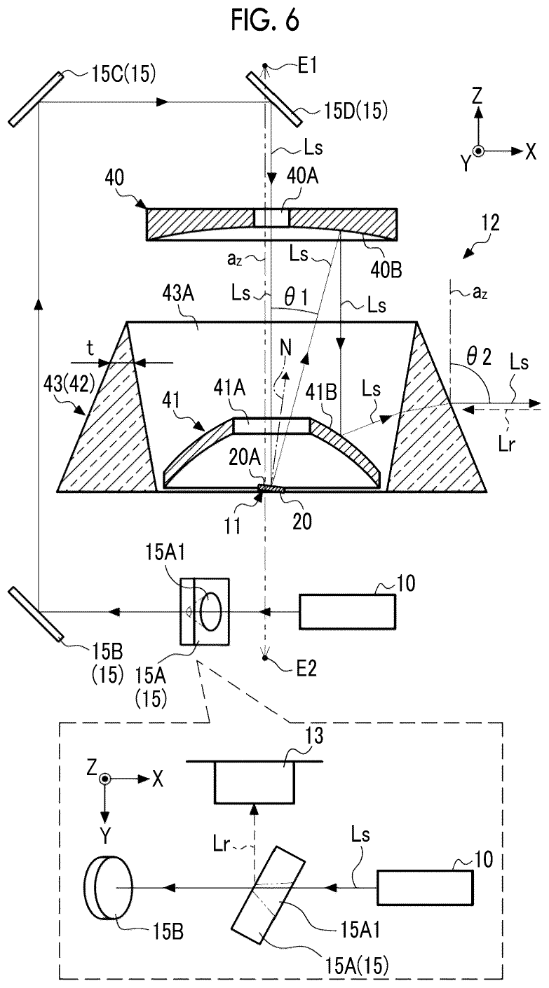

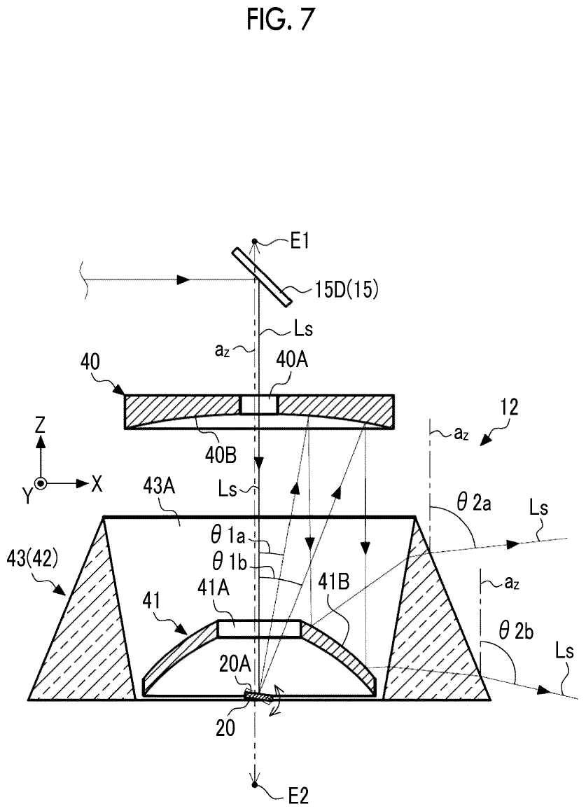

FIGS. 4 to 7 illustrate configurations of the emission angle changing optical system 12 and the incidence and emission window 42. FIG. 4 is a schematic perspective view of the emission angle changing optical system 12 and the incidence and emission window 42. FIG. 5 is a schematic exploded perspective view of the emission angle changing optical system 12 and the incidence and emission window 42. FIGS. 6 and 7 are schematic cross-sectional views of the emission angle changing optical system 12 and the incidence and emission window 42 taken along the Z axis a_{Z}.

As illustrated in FIGS. 4 and 5, the emission angle changing optical system 12 includes the first annular reflection mirror 40 and the second annular reflection mirror 41. Both of the first annular reflection mirror 40 and the second annular reflection mirror 41 have shapes that are rotationally symmetric about the Z axis a_{Z}. The first annular reflection mirror 40 and the second annular reflection mirror 41 are disposed in an order of the first annular reflection mirror 40 and the second annular reflection mirror 41 along a traveling direction of the scanning light Ls emitted from the light source 10.

In the first annular reflection mirror 40, an opening 40A through which the laser light passes is formed at a center corresponding to the Z axis a_{Z}. The first annular reflection mirror 40 has a first reflection surface 40B having an annular shape that is centered at the Z axis a_{Z} and that extends in a diameter direction orthogonal to the Z axis a_{Z}. The first reflection surface 40B is formed on a side of the first annular reflection mirror 40 closer to the second annular reflection mirror 41. In addition, a cross-sectional shape of the first reflection surface 40B taken along a plane parallel to the Z axis a_{Z} is a concave shape.

The scanning light Ls emitted from the movable mirror portion 20 is incident on the first reflection surface 40B. The first reflection surface 40B reflects the incident scanning light Ls.

In the second annular reflection mirror 41, an opening 41A through which the laser light passes is formed at a center corresponding to the Z axis a_{Z}. A second reflection surface 41B is formed on a side of the second annular reflection mirror 41 closer to the first annular reflection mirror 40. The second reflection surface 41B has an annular shape that is centered at the Z axis a_{Z} and that extends in the diameter direction orthogonal to the Z axis a_{Z}. In addition, a cross-sectional shape of the second reflection surface 41B taken along a plane parallel to the Z axis a_{Z} is a convex shape toward the side closer to the first end E1.

The scanning light Ls is incident on the second reflection surface 41B from the first reflection surface 40B. The second reflection surface 41B reflects the incident scanning light Ls. An optical path of the scanning light Ls reflected by the second reflection surface 41B is in an outward direction from the Z axis a_{Z}. The outward direction from the Z axis a_{Z} is a radius direction of a circle centered at an intersection between the outward direction and the Z axis a_{Z}.

The incidence and emission window 42 has an annular shape centered at the Z axis a_{Z}. The incidence and emission window 42 is capable of omnidirectionally emitting the scanning light Ls about the Z axis a_{Z}, and the incidence and emission window 42 is capable of receiving the returning light Lr incident from the target object 3. That is, the incidence and emission window 42 is transparent with respect to the scanning light Ls and the returning light Lr. The incidence and emission window 42 is, for example, an omnidirectional lens 43. The incidence and emission window 42 is an example of an “incidence and emission window” according to the disclosed technology. The omnidirectional lens 43 is an example of an “omnidirectional lens” according to the disclosed technology.

The omnidirectional lens 43 has a shape that is rotationally symmetric about the Z axis a_{Z}. In the omnidirectional lens 43, a cavity 43A for accommodating the second annular reflection mirror 41 is formed at a center. The omnidirectional lens 43 is disposed outside the second annular reflection mirror 41. The scanning light Ls is incident on the omnidirectional lens 43 from the second reflection surface 41B.

As illustrated in FIG. 6, the emission angle changing optical system 12 is disposed on the side closer to the first end E1 of the Z axis a_{Z}. In the emission angle changing optical system 12, an emission angle θ2 that is an angle of the scanning light Ls emitted from the omnidirectional lens 43 with respect to the Z axis a_{Z} is greater than a reflection angle θ1 that is an angle of the scanning light Ls reflected by the movable mirror portion 20 with respect to the Z axis a_{Z}.

The relay optical system 15 is disposed on the optical path of the scanning light Ls emitted from the light source 10. The relay optical system 15 includes a first relay element 15A, a second relay element 15B, a third relay element 15C, and a fourth relay element 15D. The first relay element 15A is an example of a “first relay element” according to the disclosed technology. The second relay element 15B is an example of a “second relay element” according to the disclosed technology. The third relay element 15C is an example of a “third relay element” according to the disclosed technology. The fourth relay element 15D is an example of a “fourth relay element” according to the disclosed technology.

The first relay element 15A is disposed on the side closer to the second end E2 like the light source 10 and the light receiving sensor 13. The first relay element 15A allows transmission of the scanning light Ls from the light source 10 and reflects the returning light Lr to cause the returning light Lr to be incident on the light receiving sensor 13. That is, the first relay element 15A is a branch optical element. For example, the first relay element 15A is a total reflection mirror having a through-hole 15A1. For example, the through-hole 15A1 has a shape that has a central axis along the optical path and of which an opening diameter is gradually decreased from a side closer to the light source 10 to its opposite side. In the through-hole 15A1, the opening diameter on the side opposite to the light source 10 is set to be a sufficiently small diameter with respect to a spread of the returning light Lr. Accordingly, the returning light Lr is reflected by the first relay element 15A. While the total reflection mirror having the through-hole 15A1 has been illustratively described as the first relay element 15A, the disclosed technology is not limited to this. As the first relay clement 15A, for example, a half mirror may be used, or a polarized light beam splitter may be used. In a case where the half mirror is used, the half mirror allows transmission of a part of each of the scanning light Ls and the returning light Lr and reflects the rest. In a case where the polarized light beam splitter is used, the polarized light beam splitter allows transmission of one of p polarized light and s polarized light of each of the scanning light Ls and the returning light Lr and reflects the other.

The scanning light Ls emitted from the light source 10 is transmitted through the first relay element 15A and is then incident on the second relay element 15B. The second relay clement 15B is disposed on the side closer to the second end E2 of the Z axis a_{Z}. The second relay element 15B reflects the scanning light Ls toward the side closer to the first end E1 of the Z axis a_{Z}. The second relay element 15B is, for example, a total reflection mirror of which a reflection surface is disposed at an inclination of 45° with respect to each of an X axis aₓ and the Z axis a_{Z}. Accordingly, the optical path of the scanning light Ls is bent to the Z axis direction from the X axis direction.

The third relay element 15C is disposed on the side closer to the first end E1 of the Z axis a_{Z}. The third relay element 15C reflects the scanning light Ls reflected by the second relay clement 15B in a direction intersecting with the Z axis a_{Z}. The third relay clement 15C is, for example, a total reflection mirror. A reflection surface of the third relay clement 15C is disposed at an inclination of 45° with respect to each of the X axis aₓ and the Z axis a_{Z}, and an inclination direction is a direction in which the reflection surface of the third relay element 15C faces the reflection surface of the second relay element 15B. Accordingly, the optical path of the scanning light Ls reflected by the second relay element 15B is bent to the X axis direction from the Z axis direction.

The fourth relay element 15D is disposed on the side closer to the first end E1 of the Z axis a_{Z}. The fourth relay element 15D reflects the scanning light Ls reflected by the third relay clement 15C toward the movable mirror portion 20. The fourth relay element 15D is, for example, a total reflection mirror. A reflection surface of the fourth relay element 15D is disposed at an inclination of 45° with respect to each of the X axis aₓ and the Z axis a_{Z}, and an inclination direction is a direction in which the reflection surface of the fourth relay element 15D faces the reflection surface of the third relay element 15C. Accordingly, the optical path of the scanning light Ls reflected by the third relay element 15C is bent to the Z axis direction from the X axis direction.

Each of a plurality of optical elements such as the first relay element 15A to the fourth relay element 15D is an optical element that can be used for optical axis adjustment. Accordingly, by comprising the relay optical system 15 including the plurality of optical elements in the LiDAR device 2, the number of position adjustment components that can be used for the optical axis adjustment is increased. Thus, the optical axis adjustment is facilitated.

The scanning light Ls that has passed through the relay optical system 15 travels along the Z axis a_{Z} from the side closer to the first end E1. The scanning light Ls is incident on the movable mirror portion 20 by passing through the opening 40A of the first annular reflection mirror 40 and the opening 41A of the second annular reflection mirror 41. The scanning light Ls incident on the movable mirror portion 20 is reflected by the movable reflection surface 20A. The scanning light Ls emitted from the movable mirror portion 20 is incident on the first reflection surface 40B of the first annular reflection mirror 40 by passing through the opening 41A of the second annular reflection mirror 41.

The scanning light Ls incident on the first reflection surface 40B is reflected by the first reflection surface 40B. The scanning light Ls emitted from the first reflection surface 40B is incident on the second reflection surface 41B of the second annular reflection mirror 41.

The scanning light Ls incident on the second reflection surface 41B is reflected by the second reflection surface 41B. The scanning light Ls emitted from the second reflection surface 41B travels outward in the diameter direction orthogonal to the Z axis a_{Z} to be incident on the omnidirectional lens 43.

In the omnidirectional lens 43, a cross-sectional shape (hereinafter, simply referred to as a “longitudinal cross-sectional shape”) along a direction parallel to the Z axis a_{Z} is a shape of which a thickness t is increased from the side closer to the first end E1 toward the side closer to the second end E2 of the Z axis a_{Z}. For example, in the omnidirectional lens 43, the longitudinal cross-sectional shape is a triangular shape. However, this is merely an example. The longitudinal cross-sectional shape in the omnidirectional lens 43 may be a trapezoidal shape.

The omnidirectional lens 43 has a refractive power for refracting the scanning light Ls. The omnidirectional lens 43 refracts the scanning light Ls incident from the second reflection surface 41B and emits the scanning light Ls. Since the thickness t is increased from the side closer to the first end E1 toward the side closer to the second end E2, the omnidirectional lens 43 bends the scanning light Ls incident from the second reflection surface 41B to the side closer to the second end E2. For example, in a case where a ray of the scanning light Ls illustrated in FIG. 6 is used as an example for description, the omnidirectional lens 43 brings an emission direction of the scanning light Ls reflected in an oblique upward direction by the second reflection surface 41B close to a horizontal direction.

The returning light Lr from the target object 3 is incident on the omnidirectional lens 43 and travels in a reverse direction of a traveling path of the scanning light Ls to be incident on the movable mirror portion 20. The returning light Lr is reflected by the movable mirror portion 20 and is then incident on the relay optical system 15 by passing through the opening 40A of the first annular reflection mirror 40 and the opening 41A of the second annular reflection mirror 41. The returning light Lr travels through the relay optical system 15 in the reverse direction of the traveling path of the scanning light Ls. That is, the relay optical system 15 relays the returning light Lr in an order of the fourth relay element 15D, the third relay element 15C, the second relay element 15B, and the first relay element 15A. The returning light Lr is reflected by the first relay element 15A to be incident on the light receiving sensor 13.

The first reflection surface 40B and the second reflection surface 41B are formed with metal films of, for example, gold (Au), aluminum (Al), or silver (Ag) compounds. The first reflection surface 40B and the second reflection surface 41B may be formed with a multilayer reflection film.

The omnidirectional lens 43 is formed of an optical resin such as an acrylic resin, polycarbonate, or Zeonex.

As illustrated in FIG. 7, in the emission angle changing optical system 12, the emission angle θ2 which is the angle of the scanning light Ls emitted from the omnidirectional lens 43 with respect to the Z axis a_{Z} is greater than the reflection angle θ1 which is the angle of the scanning light Ls reflected by the movable mirror portion 20 with respect to the Z axis a_{Z}. A range of the reflection angle θ1 of the scanning light Ls reflected by the movable mirror portion 20 corresponds to a movable range of the movable mirror portion 20. Thus, in the emission angle changing optical system 12, a range of the emission angle θ2 is set to be wider than the range of the reflection angle θ1 defined by the movable range of the movable mirror portion 20. That is, by reflection of the scanning light Ls by the movable mirror portion 20, the scanning light Ls is reflected within a range of a reflection angle θ1a to a reflection angle θ1b. In the emission angle changing optical system 12, the range of the reflection angle θ1 is widened to a range of an emission angle θ2a to an emission angle θ2b. For example, as illustrated in FIG. 7, the range of the emission angle θ2a to the emission angle θ2b is greater than the range of the reflection angle θ1a to the reflection angle θ1b.

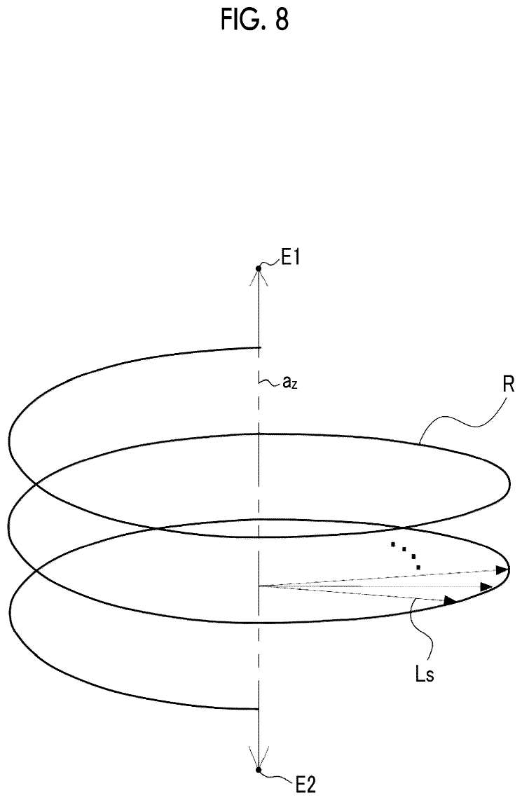

As described above, the movable mirror portion 20 performs the precessional motion. Furthermore, the angle of the scanning light Ls is changed from the reflection angle θ1a to the reflection angle θ1b by the movable mirror portion 20. Accordingly, by changing the reflection angle θ1 while performing the precessional motion, the movable mirror portion 20 changes the direction in which the scanning light Ls is emitted in a helical shape with respect to the Z axis a_{Z}. That is, the emission direction of the scanning light Ls also changes in the Z axis direction while omnidirectionally changing about the Z axis a_{Z}. Accordingly, the scanning light Ls is emitted within the range of the emission angle θ2a to the emission angle θ2b. FIG. 8 schematically illustrates a change in the emission direction of the scanning light Ls in a helical shape, and the emission direction of the scanning light Ls shows a path R in a helical shape about the Z axis a_{Z} as a central axis.

FIG. 9 is a cross-sectional perspective view illustrating a configuration example of the LiDAR device 2. While FIGS. 4 to 7 schematically illustrate constituents of the LiDAR device 2, FIG. 9 illustrates a more specific form of a configuration of the LiDAR device 2. As illustrated in FIG. 9, the LiDAR device 2 includes a housing 4. The housing 4 comprises a first housing 5 and a second housing 6 between which the omnidirectional lens 43 is sandwiched in the direction along the Z axis a_{Z}. The first housing 5 is disposed on the side closer to the second end E2 of the Z axis a_{Z}. The first housing 5 is, for example, a housing having a bottomed cylindrical shape. The light source 10 and the light receiving sensor 13 are accommodated in the first housing 5. That is, the light source 10 and the light receiving sensor 13 are disposed on the side closer to the second end E2. In addition, the first relay element 15A and the second relay clement 15B in the relay optical system 15 are accommodated in the first housing 5.

The second housing 6 is disposed on the side closer to the first end E1 of the Z axis a_{Z}. The second housing 6 is, for example, a hollow member having a trapezoidal external shape. The third relay element 15C and the fourth relay element 15D in the relay optical system 15 are accommodated in the second housing 6.

In the direction along the Z axis a_{Z}, the incidence and emission window 42 is formed between the first housing 5 and the second housing 6. The omnidirectional lens 43 as the incidence and emission window 42 is disposed on the side closer to the first end E1. For example, in the omnidirectional lens 43, the longitudinal cross-sectional shape is a pair of trapezoidal shapes having an upper bottom on a side closer to the second housing 6.

As described above, the LiDAR device 2 omnidirectionally emits the scanning light Ls about the Z axis a_{Z}. In this case, optical paths of the scanning light Ls and the returning light Lr are formed between the movable mirror portion 20 and the incidence and emission window 42. In the LiDAR device 2, electrical components such as the light receiving sensor 13 and the light source 10 are disposed on the side closer to the second end E2 of the Z axis a_{Z}. Accordingly, electrical wiring lines connected to the electrical components are laid out on only the side closer to the second end E2, and layout of the electrical wiring lines is not required on the side closer to the first end E1. Consequently, obstruction of the optical paths of the scanning light Ls and the returning light Lr by the electrical wiring lines in the direction along the Z axis a_{Z} is suppressed.

More specifically, for example, it is assumed that the light receiving sensor 13 is disposed on the side closer to the first end E1, and the light source 10 is disposed on the side closer to the second end E2. In this case, at least any of the electrical wiring line connected to the light receiving sensor 13 or the electrical wiring line connected to the light source 10 is laid out between the first housing 5 and the second housing 6 along the direction of the Z axis a_{Z}. Then, the electrical wiring line crosses the omnidirectional lens 43. Thus, the optical paths of the scanning light Ls and the returning light Lr are obstructed by the electrical wiring line. In the LiDAR device 2, as described above, since the electrical wiring lines connected to the electrical components are laid out on only the side closer to the second end E2, obstruction of the optical paths of the scanning light Ls and the returning light Lr is suppressed.

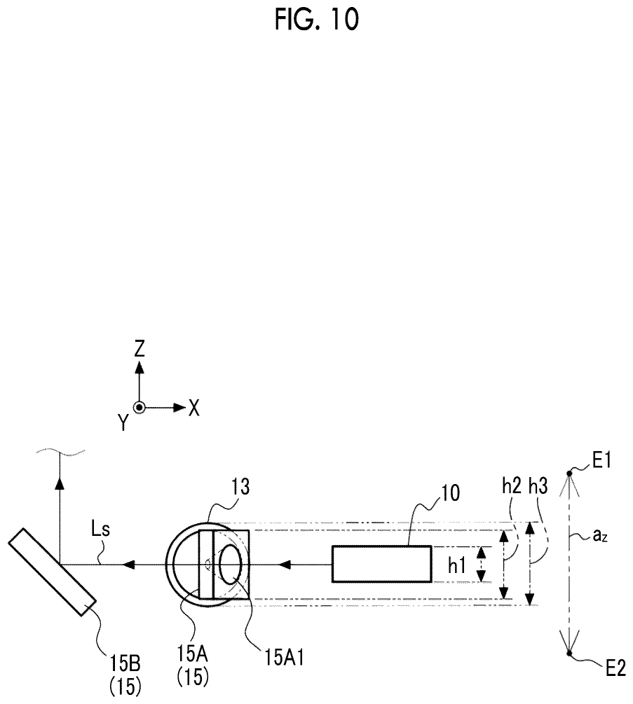

FIG. 10 is a schematic configuration diagram illustrating disposition of each element in the first housing 5 of the LiDAR device 2. In the first housing 5, the light source 10, the light receiving sensor 13, and the first relay element 15A are disposed to at least partially overlap with each other in the direction along the Z axis a_{Z}. As illustrated in FIG. 10, a range h1 of the light source 10 in the direction along the Z axis a_{Z} is included in a range h3 of the light receiving sensor 13 and a range h2 of the first relay element 15A. In addition, the range h2 of the first relay element 15A is included in the range h3 of the light receiving sensor 13.

While an example of a form in which the range h1 of the light source 10 is included in the range h3 of the light receiving sensor 13 and the range h2 of the first relay element 15A, and the range h2 of the first relay element 15A is included in the range h3 of the light receiving sensor 13 has been illustratively described in the example illustrated in FIG. 10, this is merely an example. The light source 10, the first relay element 15A, and the light receiving sensor 13 may be disposed such that one of any two of the range h1 of the light source 10, the range h2 of the first relay element 15A, and the range h3 of the light receiving sensor 13 includes the other in the direction along the Z axis a_{Z}. In addition, the light source 10, the first relay element 15A, and the light receiving sensor 13 may be disposed such that at least any two of the range h1 of the light source 10, the range h2 of the first relay element 15A, and the range h3 of the light receiving sensor 13 partially overlap with each other.

As described above, in the LiDAR device 2 according to the first embodiment, the light source 10 and the light receiving sensor 13 are disposed on the side closer to the second end E2. In addition, the scanning light Ls and the returning light Lr are relayed between the side closer to the second end E2 and the side closer to the first end E1 by the relay optical system 15. Accordingly, the electrical components (for example, the light source 10 and the light receiving sensor 13) and the electrical wiring lines connected to the electrical components are brought together on the side closer to the second end E2. Thus, according to the present configuration, size reduction of the LiDAR device 2 is implemented, compared to a case where the light source 10 and the light receiving sensor 13 are separately disposed on the side closer to the first end E1 and the side closer to the second end E2 with respect to the movable reflection surface 20A.

In addition, in the LiDAR device 2 according to the first embodiment, the movable mirror portion 20 is a two-axis rotary mirror capable of rotating about each of the axis a₁ and the axis a₂. In addition, the movable mirror portion 20 changes the direction in which the scanning light Ls is emitted in a conical shape about the Z axis a_{Z} by rotating about each of the axis a₁ and the axis a₂ in the positive direction and the negative direction with reference to the initial position. Thus, according to the present configuration, size reduction of the LiDAR device 2 is implemented, compared to a case where an inclined reflection surface is moved upward and downward along the Z axis a_{Z} while rotating about the Z axis a_{Z} as a configuration for deflecting the scanning light Ls.

In addition, in the LiDAR device 2 according to the first embodiment, the movable mirror portion 20 changes the direction in which the scanning light Ls is emitted in a helical shape about the Z axis a_{Z}. Thus, according to the present configuration, size reduction of the LIDAR device 2 is implemented, compared to a case where an inclined reflection surface is moved upward and downward along the Z axis a_{Z} while rotating about the Z axis a_{Z} as a configuration for deflecting the scanning light Ls.

In addition, in the LiDAR device 2 according to the first embodiment, the emission angle changing optical system 12 is disposed on the side closer to the first end E1. In the emission angle changing optical system 12, the emission angle θ2 which is the angle of the scanning light Ls emitted from the incidence and emission window 42 with respect to the Z axis a_{Z} is greater than the reflection angle θ1 which is the angle of the scanning light Ls reflected by the movable reflection surface 20A with respect to the Z axis a_{Z}. Accordingly, the emission angle θ2 of the scanning light Ls can be inclined with respect to the Z axis a_{Z}. Thus, according to the present configuration, size reduction of the LiDAR device 2 in the direction along the Z axis a_{Z} can be achieved, compared to a case where an inclined reflection surface is moved upward and downward along the Z axis a_{Z} while rotating about the Z axis a_{Z} as a configuration for deflecting the scanning light Ls.

For example, the two-axis rotary mirror such as a MEMS mirror generally has a narrow range of a rotation angle, compared to a mirror that is rotationally driven by a motor. In the LIDAR device 2 according to the present embodiment, even in a case where such a two-axis rotary mirror is used, the emission angle θ2 of the scanning light Ls with respect to the Z axis a_{Z} can be inclined with respect to the Z axis a_{Z} by comprising the emission angle changing optical system 12. In addition, for example, by increasing the inclination with respect to the Z axis a_{Z}, a scanning range of the scanning light Ls can be widened to the side closer to the second end E2 with respect to the direction orthogonal to the Z axis a_{Z}.

In addition, in the LiDAR device 2 according to the first embodiment, the range of the emission angle θ2 is further set to be wider than the range of the reflection angle θ1 defined by the movable range of the movable mirror portion 20 in the emission angle changing optical system 12. Thus, according to the present configuration, an emission range of the scanning light Ls can be widened, compared to a case where the scanning light Ls is deflected using only the two-axis rotary mirror.

In addition, in the LiDAR device 2 according to the first embodiment, the emission angle changing optical system 12 includes the first annular reflection mirror 40 and the second annular reflection mirror 41. The first annular reflection mirror 40 reflects the scanning light Ls toward the second reflection surface 41B via the first reflection surface 40B. The second annular reflection mirror 41 reflects the scanning light Ls incident on the second reflection surface 41B from the first reflection surface 40B toward the incidence and emission window 42. Accordingly, the optical path of the scanning light Ls is adjusted by the first reflection surface 40B and the second reflection surface 41B. Thus, according to the present configuration, the inclination of the emission angle θ2 of the scanning light Ls with respect to the Z axis a_{Z} and/or the emission range of the scanning light Ls are adjusted.

In addition, in the LiDAR device 2 according to the first embodiment, the emission angle changing optical system 12 includes the first annular reflection mirror 40 and the second annular reflection mirror 41. The first annular reflection mirror 40 has the first reflection surface 40B having an annular shape centered at the Z axis a_{Z}. The second annular reflection mirror 41 has the second reflection surface 41B having an annular shape centered at the Z axis a_{Z}. Thus, according to the present configuration, size reduction of the LiDAR device 2 is achieved, compared to a case where a mirror having a rectangular shape is used as a reflective member of the scanning light Ls of which the emission direction changes about the Z axis a_{Z}.

In addition, in the LiDAR device 2 according to the first embodiment, the incidence and emission window 42 is the omnidirectional lens 43 having a refractive power. In the omnidirectional lens 43, the cross-sectional shape in the direction along the Z axis a_{Z} is a shape of which the thickness t in the diameter direction orthogonal to the Z axis a_{Z} is increased from the side closer to the first end E1 toward the side closer to the second end E2 of the Z axis a_{Z}. Thus, according to the present configuration, the emission range of the scanning light Ls can be widened, compared to a case where the incidence and emission window 42 is an optical member not having a refractive power.

In addition, in the LiDAR device 2 according to the first embodiment, in the omnidirectional lens 43, the cross-sectional shape in the direction along the Z axis a_{Z} is a shape of which the thickness t in the diameter direction is increased from the side closer to the first end E1 toward the side closer to the second end E2 of the Z axis a_{Z}. In addition, the emission angle changing optical system 12 includes the first annular reflection mirror 40 and the second annular reflection mirror 41. The first annular reflection mirror 40 reflects the scanning light Ls that is reflected by the movable reflection surface 20A to travel toward the side closer to the first end E1, toward the second reflection surface 41B via the first reflection surface 40B. The second annular reflection mirror 41 reflects the scanning light Ls incident on the second reflection surface 41B from the first reflection surface 40B toward the incidence and emission window. Thus, according to the present configuration, the emission direction of the scanning light Ls can be brought close to the direction orthogonal to the Z axis a_{Z}, compared to a case where the omnidirectional lens 43 has a shape of which the thickness t is not increased from the side closer to the first end E1 toward the side closer to the second end E2.

In addition, in the LiDAR device 2 according to the first embodiment, the relay optical system 15 comprises the first relay element 15A, and the first relay element 15A is disposed on the side closer to the second end E2, in addition to the light source 10 and the light receiving sensor 13. The light source 10, the light receiving sensor 13, and the first relay element 15A are disposed to at least partially overlap with each other in the direction along the Z axis a_{Z}. Thus, according to the present configuration, size reduction of the LiDAR device 2 can be implemented in the direction along the Z axis a_{Z}, compared to a case where the light source 10, the light receiving sensor 13, and the first relay element 15A are disposed without overlapping with each other in the direction along the Z axis a_{Z}.

In addition, in the LiDAR device 2 according to the first embodiment, the relay optical system 15 includes the second relay element 15B, the third relay element 15C, and the fourth relay element 15D. Thus, according to the present configuration, optical path adjustment of the scanning light Ls and the returning light Lr is facilitated, compared to a case where the relay optical system 15 consists of a single optical element.

In addition, in the LiDAR device 2 according to the first embodiment, the light receiving sensor 13 is composed of one photodiode. Thus, according to the present configuration, size reduction of the LiDAR device 2 can be achieved, compared to a case where the light receiving sensor 13 is a line sensor or a two-dimensional sensor including a plurality of photodiodes.

In addition, in the LiDAR device 2 according to the first embodiment, the light source 10 is a laser light source that emits laser light as the scanning light Ls. Thus, according to the present configuration, directivity of the scanning light Ls is increased, and accuracy of the measurement of the distance to the target object 3 is increased, compared to a case where incoherent light is used as the scanning light Ls.

### Modification Example 1

While an example of a form in which the electrical components such as the light source 10 and the light receiving sensor 13 are disposed on the side closer to the second end E2 of the Z axis a_{Z} in the LiDAR device 2 according to the first embodiment has been illustratively described, the disclosed technology is not limited to this. In the present modification example, an angle sensor 50 that detects a rotation angle of the movable reflection surface 20A of the movable mirror portion 20 is disposed on the side closer to the second end E2 of the Z axis a_{Z}, in addition to the light source 10 and the light receiving sensor 13.

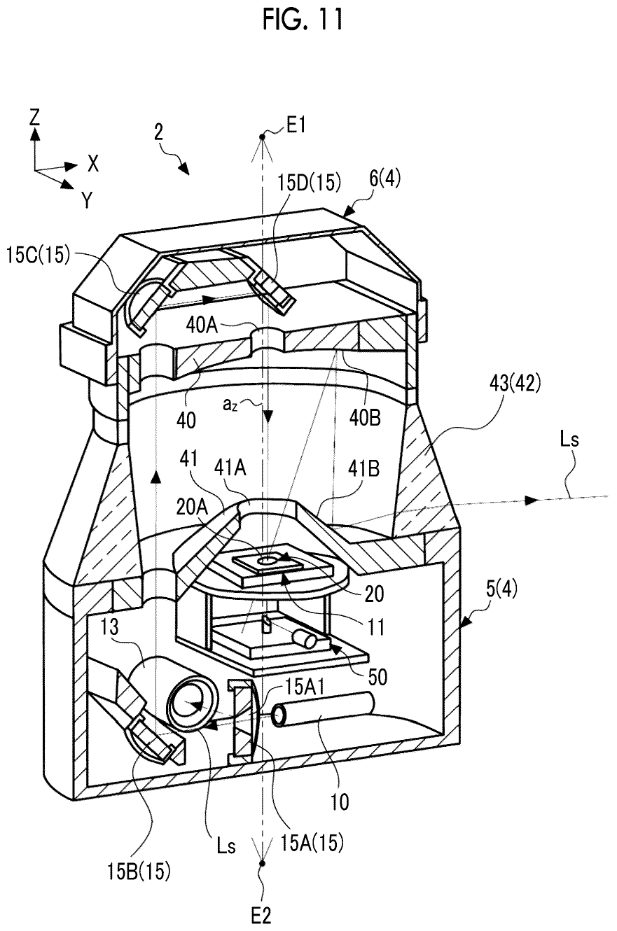

FIG. 11 is a cross-sectional perspective view illustrating a configuration example of the LiDAR device 2. As illustrated in FIG. 11, the angle sensor 50 is accommodated in the first housing 5 and is disposed on the side closer to the second end E2 of the Z axis a_{Z}. The angle sensor 50 detects the rotation angle of the movable reflection surface 20A of the movable mirror portion 20 about each of the axis a₁ and the axis a₂. The angle sensor 50 is an example of an “angle sensor” according to the disclosed technology.

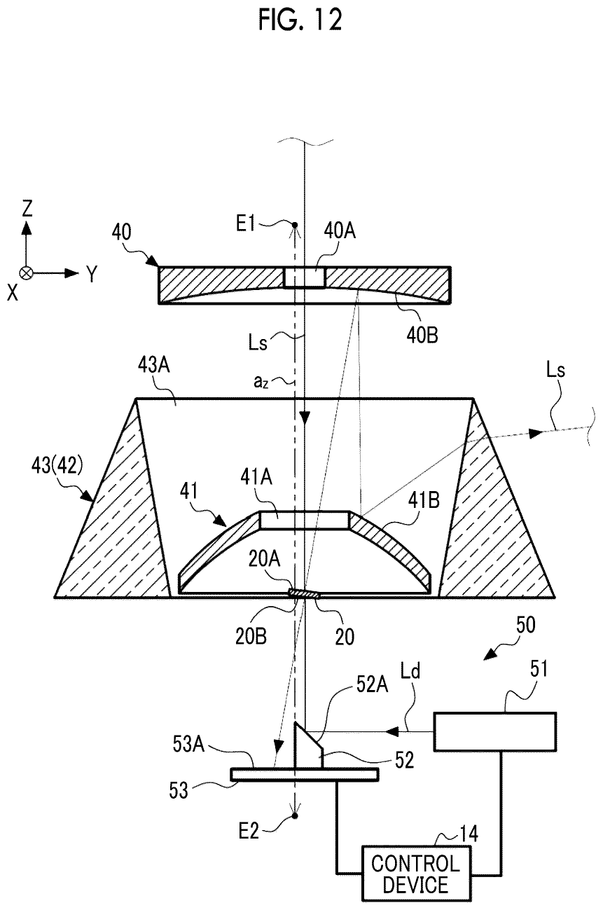

FIG. 12 is a schematic configuration diagram illustrating disposition of the angle sensor 50. As illustrated in FIG. 12, the angle sensor 50 includes an angle detection light source 51, an angle changing member 52, and a detection element 53. The angle detection light source 51 emits detection light Ld toward the angle changing member 52. For example, the angle detection light source 51 is a laser light source, and the detection light Ld is laser light. The angle changing member 52 is a member including a reflection surface 52A. The reflection surface 52A reflects the detection light Ld toward an inner surface 20B of the movable reflection surface 20A of the movable mirror portion 20.

The detection light Ld reflected by the reflection surface 52A is further reflected by the inner surface 20B. Here, in a case where the movable reflection surface 20A reaches a certain rotation angle, the inner surface 20B reaches a rotation angle corresponding to the movable reflection surface 20A. Accordingly, the detection light Ld reflected by the inner surface 20B is reflected in a direction corresponding to the rotation angle of the movable reflection surface 20A.

The detection light Ld reflected by the inner surface 20B is incident on the detection element 53. The detection element 53 outputs a signal corresponding to a position at which the detection light Ld is detected. The detection element 53 is, for example, a two-dimensional line sensor comprising a light receiving surface 53A. A normal direction of the light receiving surface 53A is the direction along the Z axis a_{Z}. The control device 14 calculates the rotation angle of the movable reflection surface 20A based on the signal output from the detection element 53.

As described above, in the LiDAR device 2 according to the first modification example, the angle sensor 50 for detecting the rotation angle of the movable reflection surface 20A is provided. The angle sensor 50 is disposed on the side closer to the second end E2 of the Z axis a_{Z} with respect to the movable reflection surface 20A of the movable mirror portion 20. Thus, according to the present configuration, size reduction of the LIDAR device 2 is implemented, compared to a case where the angle sensor 50 is disposed on the side closer to the first end E1.

That is, the angle sensor 50 is an electrical component like the light source 10 and the light receiving sensor 13. Accordingly, since the electrical components and the wiring lines connected to the electrical components are brought together on the side closer to the second end E2 of the Z axis a_{Z}, size reduction of the LiDAR device 2 is implemented.

### Modification Example 2

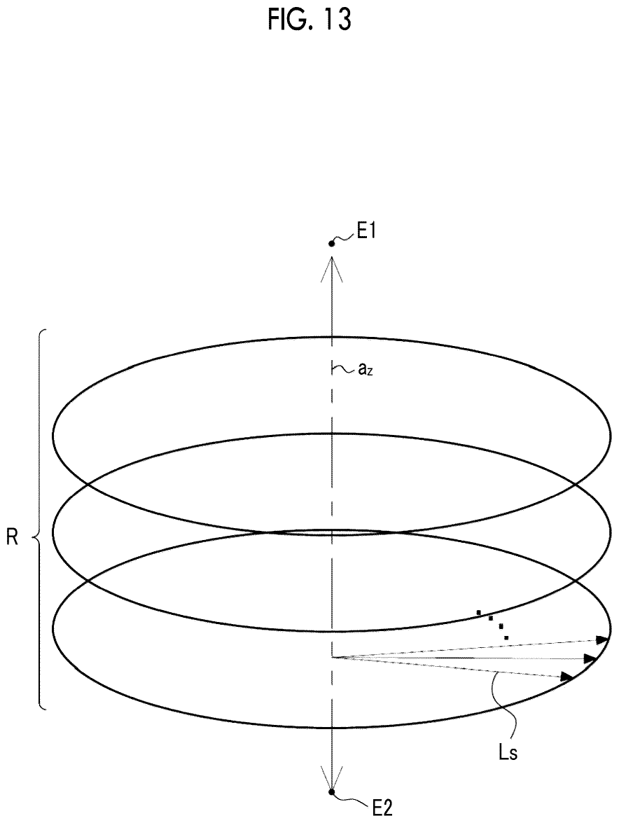

While an example of a form in which the path R of the scanning light Ls emitted from the LiDAR device 2 has a helical shape has been illustratively described in the first embodiment, the disclosed technology is not limited to this. An example of the path R of the scanning light Ls other than the helical shape is illustrated in FIG. 13. In the example illustrated in FIG. 13, unlike the example of the helical shape illustrated in FIG. 8, the emission direction of the scanning light Ls is not changed in the direction of the Z axis a_{Z} while the emission direction rotates about the Z axis a_{Z}. After the emission direction rotates once or more about the Z axis a_{Z}, the emission direction is moved in the direction of the Z axis a_{Z}. Rotation of the emission direction about the Z axis a_{Z} and movement of the emission direction in the direction of the Z axis a_{Z} are performed in a stepwise manner.

In a case where the emission direction of the scanning light Ls is changed as in FIG. 13, the movable mirror portion 20 is driven as follows. First, the precessional motion of the movable mirror portion 20 is performed in a state where an inclination angle of the movable mirror portion 20 with respect to the Z axis a_{Z} is maintained to be constant. After the emission direction is rotated once or more, the precessional motion is temporarily stopped, and the inclination angle of the movable mirror portion 20 is changed. After the inclination angle is changed, the precessional motion is started again. In a case where the inclination angle of the movable mirror portion 20 is changed in a stepwise manner by repeating this operation, movement of the emission direction in the direction of the Z axis a_{Z} is performed as illustrated in FIG. 13.

### Second Embodiment

While an example of a form in which the emission angle changing optical system 12 includes the first annular reflection mirror 40 and the second annular reflection mirror 41 has been illustratively described in the first embodiment, the disclosed technology is not limited to this. In the second embodiment, the emission angle changing optical system 12 includes a third annular reflection mirror 44 instead of the first annular reflection mirror 40 and the second annular reflection mirror 41.

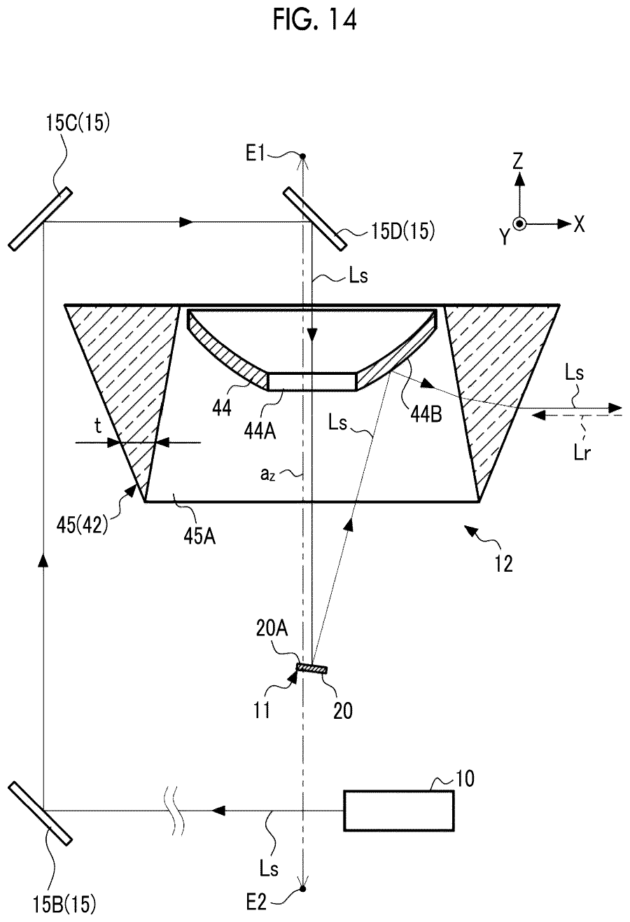

FIG. 14 is a schematic cross-sectional view of the emission angle changing optical system 12 and the incidence and emission window 42 taken along the Z axis a_{Z}. As illustrated in FIG. 14, the emission angle changing optical system 12 includes the third annular reflection mirror 44. The third annular reflection mirror 44 has a shape that is rotationally symmetric about the Z axis a_{Z}. In the third annular reflection mirror 44, an opening 44A through which the scanning light Ls passes is formed at a center corresponding to the Z axis a_{Z}. The third annular reflection mirror 44 has a third reflection surface 44B having an annular shape that is centered at the Z axis a_{Z} and that extends in the diameter direction orthogonal to the Z axis a_{Z}. The third reflection surface 44B is formed on a side of the third annular reflection mirror 44 closer to the movable reflection surface 20A. In addition, a cross-sectional shape of the third reflection surface 44B taken along the plane parallel to the Z axis a_{Z} is a convex shape toward the side closer to the second end E2.

The incidence and emission window 42 is, for example, an omnidirectional lens 45. The omnidirectional lens 45 has a shape that is rotationally symmetric about the Z axis a_{Z}. In the omnidirectional lens 45, a cavity 45A for accommodating the third annular reflection mirror 44 is formed at a center. The omnidirectional lens 45 is rotationally symmetric about the Z axis a_{Z} and is disposed outside the third annular reflection mirror 44. In addition, in the omnidirectional lens 45, a cross-sectional shape along the direction parallel to the Z axis a_{Z} is a shape of which the thickness t is increased from the side closer to the second end E2 of the Z axis a_{Z} toward the side closer to the first end E1. The scanning light Ls is incident on the omnidirectional lens 45 from the third reflection surface 44B. The omnidirectional lens 45 has a refractive power for refracting the scanning light Ls. The omnidirectional lens 45 refracts the scanning light Ls incident from the third reflection surface 44B and emits the scanning light Ls. The omnidirectional lens 45 is an example of the “omnidirectional lens” according to the disclosed technology.

Since the thickness t is increased from the side closer to the second end E2 toward the side closer to the first end E1, the omnidirectional lens 45 bends the scanning light Ls incident from the third reflection surface 44B to the side closer to the first end E1. For example, in a case where a ray of the scanning light Ls illustrated in FIG. 14 is used as an example for description, the omnidirectional lens 45 brings the emission direction of the scanning light Ls reflected in an oblique downward direction by the third reflection surface 44B close to the horizontal direction.

The scanning light Ls that has passed through the relay optical system 15 is incident on the movable mirror portion 20 by passing through the opening 44A of the third annular reflection mirror 44. The scanning light Ls incident on the movable mirror portion 20 is reflected by the movable reflection surface 20A. The scanning light Ls emitted from the movable reflection surface 20A travels to the side closer to the first end E1 and is then incident on the third reflection surface 44B of the third annular reflection mirror 44.

The scanning light Ls incident on the third reflection surface 44B is reflected by the third reflection surface 44B. The scanning light Ls emitted from the third reflection surface 44B travels outward in the diameter direction orthogonal to the Z axis a_{Z} to be incident on the omnidirectional lens 45. The scanning light Ls incident on the omnidirectional lens 45 is refracted and is then emitted toward the target object 3 (refer to FIG. 1) from the omnidirectional lens 45.

The returning light Lr from the target object 3 is incident on the omnidirectional lens 45 and travels in the reverse direction of the traveling path of the scanning light Ls to be incident on the movable mirror portion 20. The returning light Lr is reflected by the movable reflection surface 20A and is then incident on the relay optical system 15 by passing through the opening 44A of the third annular reflection mirror 44. The returning light Lr travels through the relay optical system 15 in the reverse direction of the traveling path of the scanning light Ls.

As described above, in the LiDAR device 2 according to the second embodiment, the emission angle changing optical system 12 includes the third annular reflection mirror 44. The third annular reflection mirror 44 reflects the scanning light Ls toward the incidence and emission window 42 via the third reflection surface 44B. Accordingly, the optical path of the scanning light Ls is adjusted by the third reflection surface 44B. Thus, according to the present configuration, the inclination of the emission angle θ2 of the scanning light Ls with respect to the Z axis a_{Z} and/or the emission range of the scanning light Ls are adjusted.

In addition, in the LiDAR device 2 according to the second embodiment, the emission angle changing optical system 12 includes the third annular reflection mirror 44. The third annular reflection mirror 44 has the third reflection surface 44B having an annular shape centered at the Z axis a_{Z}. Thus, according to the present configuration, size reduction of the LiDAR device 2 is achieved, compared to a case where a mirror having a rectangular shape is used as a reflective member of the scanning light Ls of which the emission direction changes about the Z axis a_{Z}.

In addition, in the LiDAR device 2 according to the second embodiment, the incidence and emission window 42 is the omnidirectional lens 45 having a refractive power. In the omnidirectional lens 45, the cross-sectional shape in the direction along the Z axis a_{Z} is a shape of which the thickness t in the diameter direction orthogonal to the Z axis a_{Z} is increased from the side closer to the second end E2 of the Z axis a_{Z} toward the side closer to the first end E1. Thus, according to the present configuration, the emission range of the scanning light Ls can be widened, compared to a case where the incidence and emission window 42 is an optical member not having a refractive power.

In addition, in the LiDAR device 2 according to the second embodiment, in the omnidirectional lens 45, the cross-sectional shape in the direction along the Z axis a_{Z} is a shape of which the thickness t in the diameter direction is increased from the side closer to the second end E2 of the Z axis a_{Z} toward the side closer to the first end E1. In addition, the emission angle changing optical system 12 includes the third annular reflection mirror 44, and the third annular reflection mirror 44 reflects the scanning light Ls toward the incidence and emission window 42 via the third reflection surface 44B. Thus, according to the present configuration, the emission direction of the scanning light Ls can be brought close to the direction orthogonal to the Z axis a_{Z}, compared to a case where the omnidirectional lens 45 has a shape of which the thickness t is not increased from the side closer to the second end E2 toward the side closer to the first end E1.

While an example of a form in which each of the second relay clement 15B, the third relay element 15C, and the fourth relay element 15D constituting the relay optical system 15 is the total reflection mirror has been illustratively described in each embodiment, the disclosed technology is not limited to this. The second relay element 15B, the third relay element 15C, and the fourth relay element 15D may be optical elements capable of reflecting the scanning light Ls and the returning light Lr and may be, for example, prisms.

In addition, while an example of a form in which the relay optical system 15 is configured to include the first relay element 15A to the fourth relay element 15D has been illustratively described in each embodiment, the disclosed technology is not limited to this. The relay optical system 15 may include other optical elements in addition to the first relay element 15A to the fourth relay element 15D or may be configured by omitting or changing a part of the first relay element 15A to the fourth relay element 15D.

In addition, while an example of a form in which the longitudinal cross-sectional shapes of the omnidirectional lenses 43 and 45 are triangular shapes or trapezoidal shapes has been illustratively described in each embodiment, the disclosed technology is not limited to this. The longitudinal cross-sectional shapes of the omnidirectional lenses 43 and 45 may be rectangular shapes.

In addition, while an example of a form in which the omnidirectional lenses 43 and 45 having a refractive power are used as a member constituting the incidence and emission window 42 has been illustratively described in each embodiment, the disclosed technology is not limited to this. For example, a member that does not have a refractive power and that is transparent with respect to the scanning light Ls and the returning light Lr may be used as the incidence and emission window 42.

In addition, while an incidence direction of the scanning light Ls on the movable mirror portion 20 is the Z axis direction in each embodiment, the incidence direction of the scanning light Ls on the movable mirror portion 20 is not limited to the Z axis direction and may be a direction intersecting with the Z axis direction.

In addition, the LiDAR device 2 of which the scanning range of the laser light is, for example, 270° or 180° can also be configured by cutting out a part of the emission angle changing optical system 12 in each embodiment.

Above described content and illustrated content are detailed description for parts according to the disclosed technology and are merely an example of the disclosed technology. For example, description related to the above configurations, functions, actions, and effects is description related to examples of configurations, functions, actions, and effects of the parts according to the disclosed technology. Thus, it is, of course, possible to remove unnecessary parts, add new elements, or replace parts in the above described content and the illustrated content without departing from the gist of the disclosed technology. In addition, particularly, description related to common technical knowledge or the like that is not required to be described for embodying the disclosed technology is omitted in the above described content and the illustrated content in order to avoid complication and facilitate understanding of the parts according to the disclosed technology.

In the present specification, “A and/or B” is synonymous with “at least one of A or B”. This means that “A and/or B” may be only A, only B, or a combination of A and B. In addition, in the present specification, the same approach as “A and/or B” is applied to a case where three or more matters are represented by connecting the matters with “and/or”.

All documents, patent applications, and technical standards described in the present specification are incorporated in the present specification by reference to the same extent as in a case where each of the documents, the patent applications, and the technical standards are specifically and individually indicated to be incorporated by reference.

The disclosure of JP2022-021534 filed on Feb. 15, 2022 is incorporated in the present specification by reference in its entirety.

What is claimed is:

1. A distance measurement device that measures a distance to a target object by emitting scanning light and receiving returning light obtained by reflection of the scanning light by the target object, the distance measurement device comprising:
a light source that emits the scanning light;
a light receiving sensor that receives the returning light and that outputs a light receiving signal corresponding to the received returning light;
an incidence and emission window that has an annular shape centered at a reference axis set in advance and that is capable of omnidirectionally emitting the scanning light about the reference axis and capable of receiving the returning light incident from the target object;
a light deflector that includes a movable mirror portion which includes a movable reflection surface disposed at a position at which the movable reflection surface intersects with the reference axis and which reflects the scanning light from the light source toward the incidence and emission window and reflects the returning light from the incidence and emission window toward the light receiving sensor, and that omnidirectionally changes a direction of the scanning light by changing a posture of the movable reflection surface; and
a relay optical system that relays the scanning light and the returning light between the movable mirror portion and each of the light source and the light receiving sensor,
wherein in a direction along the reference axis, in a case where a direction in which the movable reflection surface faces with reference to the light deflector is referred to as a side closer to a first end of the reference axis, and a side opposite to the side closer to the first end of the reference axis is referred to as a side closer to a second end of the reference axis, the incidence and emission window is disposed on the side closer to the first end, and the light source and the light receiving sensor are disposed on the side closer to the second end.

2. The distance measurement device according to claim 1,
wherein in a case where two axes orthogonal to each other in a plane of which a normal is the reference axis are referred to as a first axis and a second axis,
the movable mirror portion is a two-axis rotary mirror capable of rotating about each of the first axis and the second axis and, in a case where a position at which the movable reflection surface is orthogonal to the reference axis is referred to as an initial position, the movable mirror portion changes a direction in which the scanning light is emitted in a conical shape about the reference axis by rotating about each of the first axis and the second axis in a positive direction and a negative direction with reference to the initial position.

3. The distance measurement device according to claim 2,
wherein the movable mirror portion changes the direction in which the scanning light is emitted in a helical shape about the reference axis.

4. The distance measurement device according to claim 2, further comprising:
an emission angle changing optical system disposed on the side closer to the first end,
wherein in the emission angle changing optical system, an emission angle that is an angle of the scanning light emitted from the incidence and emission window with respect to the reference axis is set to be greater than a reflection angle that is an angle of the scanning light reflected by the movable reflection surface with respect to the reference axis.

5. The distance measurement device according to claim 4,
wherein in the emission angle changing optical system, a range of the emission angle is further set to be wider than a range of the reflection angle defined by a movable range of the movable mirror portion.

6. The distance measurement device according to claim 4,
wherein in a case where the scanning light that passes through the relay optical system to travel along the reference axis from the side closer to the first end is incident on the movable mirror portion,
the emission angle changing optical system includes
a first annular reflection mirror having a first reflection surface on which an opening through which the scanning light passes is formed at a center corresponding to the reference axis, the first reflection surface having an annular shape that is centered at the reference axis and that extends in a diameter direction orthogonal to the reference axis, and
a second annular reflection mirror having a second reflection surface disposed to face the first reflection surface, the second reflection surface having an annular shape in which an opening is formed at a center like the first reflection surface and having a convex shape toward the side closer to the first end,
the first annular reflection mirror reflects the scanning light that is reflected by the movable reflection surface to travel toward the side closer to the first end, toward the second reflection surface via the first reflection surface, and
the second annular reflection mirror reflects the scanning light incident on the second reflection surface from the first reflection surface toward the incidence and emission window.

7. The distance measurement device according to claim 4,
wherein in a case where the scanning light that passes through the relay optical system to travel along the reference axis from the side closer to the first end is incident on the movable mirror portion,
the emission angle changing optical system includes a third annular reflection mirror having a third reflection surface on which an opening through which the scanning light passes is formed at a center corresponding to the reference axis, the third reflection surface having an annular shape that is centered at the reference axis and that extends in a diameter direction orthogonal to the reference axis and having a convex shape toward the side closer to the second end, and
the third annular reflection mirror reflects the scanning light that is reflected by the movable reflection surface to travel toward the side closer to the first end, toward the incidence and emission window via the third reflection surface.

8. The distance measurement device according to claim 1,
wherein the incidence and emission window is an omnidirectional lens having a refractive power for refracting the omnidirectionally emitted scanning light, and
in the omnidirectional lens, a cross-sectional shape in the direction along the reference axis is a shape of which a thickness in a diameter direction orthogonal to the reference axis is increased from one of the side closer to the first end and the side closer to the second end of the reference axis toward the other.

9. The distance measurement device according to claim 6,
wherein in the omnidirectional lens, a cross-sectional shape in the direction along the reference axis is a shape of which a thickness in a diameter direction is increased from the side closer to the first end toward the side closer to the second end of the reference axis.

10. The distance measurement device according to claim 7,
wherein in the omnidirectional lens, a cross-sectional shape in the direction along the reference axis is a shape of which a thickness in a diameter direction is increased from the side closer to the second end toward the side closer to the first end of the reference axis.

11. The distance measurement device according to claim 1,
wherein a first relay element that constitutes a part of the relay optical system and that allows transmission of the scanning light emitted by the light source and reflects the returning light to the light receiving sensor is disposed on the side closer to the second end, and
the light source, the light receiving sensor, and the first relay element are further disposed to at least partially overlap with each other in the direction along the reference axis.

12. The distance measurement device according to claim 11,
wherein the relay optical system includes
a second relay element that is disposed on the side closer to the second end and that reflects the scanning light which has passed through the first relay element to the side closer to the first end,
a third relay element that is disposed on the side closer to the first end and that reflects the scanning light reflected by the second relay element in a direction intersecting with the reference axis, and
a fourth relay element that is disposed on the side closer to the first end and that reflects the scanning light reflected by the third relay element toward the movable mirror portion, and
the relay optical system relays the returning light in an order of the fourth relay element, the third relay element, the second relay element, and the first relay element.

13. The distance measurement device according to claim 1,
wherein the light receiving sensor is composed of one photodiode.

14. The distance measurement device according to claim 1,
wherein the light source is a laser light source that emits laser light as the scanning light.

15. The distance measurement device according to claim 1, further comprising:
an angle sensor for detecting a rotation angle of the movable reflection surface,
wherein the angle sensor is disposed on the side closer to the second end.
